(19) United States
(12) Patent Application Publication
(10) Pub. No.: US 2015/0298053 A1
(43) Pub. Date: Oct. 22, 2015

(54) Methods and Apparatuses for Energy Efficient Water Extraction from Air

(71) Applicant: Anthony Mai, San Marcos, CA (US)

(72) Inventor: Anthony Mai, San Marcos, CA (US)

(73) Assignee: Anthony Mai, San Marcos, CA (US)

(21) Appl. No.: 14/258,014

(22) Filed: Apr. 22, 2014

(51) Int. Cl. B01D 53/26; C02F 1/68; B01D 46/00

(52) U.S. Cl. CPC B01D 53/265; B01D 46/0023; B01D 53/261; B01D 53/263; C02F 1/685; B01D 53/268; C02F 2103/18

(57) ABSTRACT

The present invention provides methods and apparatuses for energy efficient removal of one liquid substance from a mixture of substances, resulting in less of the said substance in the said mixture, and providing that liquid substance for purification and usage. Among other possible embodiments, the present invention provides methods and apparatuses for extracting water from mixed matters like humid air; condensing and purifying such water for usage; and providing the end mixture with less water content; at minimal cost of energy, material and environment impact. The mixture is first extracted, purified and conditioned for more efficient next steps, then the gas mixture is compressed to allow heat to dissipate at above ambient temperature, and finally the mixture is returned to ambient pressure, allowing the liquid to condense out without cooling. When water vapor condenses into liquid, a lot of latent heat is released. Prior arts of air water extraction by refrigeration condensation cost a lot of energy to fight against latent heat release. The novel methods provided by current invention avoid such energy cost by allowing the latent heat to dissipate naturally from above ambient temperature, thus result in energy savings. The present invention is also useful in other fields of substance extraction and purifications, like in removing humidity from natural gas and oil products, or in extracting alcohol or ethanol from wine production fermentation residues, or in air conditioning.

### FIELD OF INVENTION

The present invention provides a plurality of methods and apparatuses for separating a substance from a mixture; condensing it into liquid; purifying it for usage; and supplying the remainder mixture with reduced substance for usage; at minimal cost of energy, material and impact to the environment. One application of the present invention is to extract drinkable water from the atmosphere and to provide better conditioned air for closed living space. Even though embodiment discussions in this document will focus on water extraction from air, the invention can provide applications in other material processing fields, like removing water from natural gas, or extracting alcohol or ethanol from fermentation residue materials.

The invention claims processes which take certain mixed material containing water as input; separated and purified water as well as gases with reduced water content as outputs; and consume energy in the process. The input can be ambient humid air, or cold and humid air from underground caverns, or hot and humid natural gas from underground wells, or combustion exhausts from power plants or other sources, or exhausts from steam turbines. Any gas and water vapor mixture with adequate relative humidity can be used as such input. The input material can also be liquid or solid, like wet soil or fermentation products. The desired end product extracted can be other liquid than water, like alcohol or ethanol from fermentation.

The usefulness of the invented processes is in the water separated, as well as in the resulting gas with less humidity, and in reduced energy consumption. The water is useful for drinking and other purposes. Gases with less humidity are often desirable. For example ambient air with less humidity creates a more pleasant environment for human body; natural gas with less humidity is more suitable for transportation through pipelines with less harm to the equipments, combustion exhausts with water and pollutants removed cause less air pollution when emitted.

### BACKGROUND OF INVENTION

It is often desirable to remove water content and reduce humidity from gaseous, liquid and solid materials or products, to improve materials or products or preserve them for endurance. For example people dry food grains for preservation; dehumidify air in a building for human comfort and to reduce mold build up; remove water from natural gas or oil to prevent ice build up or corrosion in pipelines; remove water from compressed air to reduce machine corrosion.

Ambient air contains water vapor. Civilization has a long history of trying to extract water from the atmosphere using different methods, by natural forces or artificial apparatus. The artificial methods of atmospheric water extraction generally cost huge energy. Thus they are neither economical nor competitive against natural sources of clean water, or conventional technologies to clean existing water sources.

As environmental pollution renders natural water sources inadequate or insufficient to meet society needs, countries like China must look for alternatives. Water from air, if extracted at an affordable energy cost, has tremendous benefits and market potential. An invention that provides energy efficient water extraction to meet the requirements is thus useful and valuable.

There are many prior arts of extracting water from air by cooling and condensation. Such methods are highly energy intensive, as a lot of latent heat is released while water vapor condenses into liquid, costing large cooling power. Energy is also wasted as vast volume of air must be cooled. Heat leaks also add to the energy cost.

For the discussion of relevant prior arts, following US patents, in the format of US#######, are listed and categorized here for further reference and analysis later:

Dew collection methods using natural forces without any artificial energy input:
U.S. Pat. No. 1,816,592, U.S. Pat. No. 3,270,515, U.S. Pat. No. 3,318,107, U.S. Pat. No. 4,442,887, U.S. Pat. No. 4,726,817

Methods that use natural forces and hygroscopic liquid or other absorption media:
U.S. Pat. No. 5,846,296, U.S. Pat. No. 8,425,660

The above two types of prior arts are driven by natural forces only. The second type uses absorption media for assistance. The first type does not. In more recent times, two types of prior arts that are driven by artificial power sources emerged. The third type are listed below:

Methods that use an absorption media heated or cooled to absorb or discharge water:
U.S. Pat. No. 6,156,102, U.S. Pat. No. 6,251,172, U.S. Pat. No. 6,280,504, U.S. Pat. No. 6,290,758, U.S. Pat. No. 6,336,957
U.S. Pat. No. 8,118,912, also published as US20110056888
U.S. Pat. No. 8,506,675, also published as US20110232485
U.S. Pat. No. 8,535,486, also published as US20100258426

The above third type of prior arts relies on the assistance of an absorption media for the operations. The absorption media must be regenerated by heating so that the absorbed water content is discharged, and that the absorption media can be re-used. Such process of repeated heating and re-generation is costly in energy consumption.

More common prior arts simply use refrigeration to cool the air to condense water. A refrigerant medium is used for the operation. The refrigerant, circulating in a loop, is evaporated in one part of the loop to absorb heat to cool, and condensed in a second part to release the heat.

Methods that use a refrigerant operating in refrigeration cycle to cool and condense:
U.S. Pat. No. 5,857,344
U.S. Pat. No. 6,868,690, also published as U.S. Pat. No. 6,574,979, US20020011075, US20030159457
U.S. Pat. No. 7,886,547, also published as US2009293513
U.S. Pat. No. 8,118,912, also published as US20110056888
U.S. Pat. No. 8,302,412, also published as U.S. Pat. No. 8,650,892, US20120060531, US20130042642
U.S. Pat. No. 8,321,061, also published as US20110313577
US20130047655, US20140053580

Commercial household atmospheric water generator units exist in marketplace today all belong to the last category which uses a refrigerant running in a evaporation and condensation cycle for cooling and heating, in order to condense water out of air. Direct cooling to condense water seems obvious and can be done easily. But it does not result in good energy efficiency. It also wastes energy to repeatedly heat and cool an absorption media, like hygroscopic liquid.

For a comparison, it costs 0.72 KWH of electricity to heat one kilogram of water to boiling temperature and completely boil it off into vapor. Commercial atmospheric water makers cost about the same amount of electricity to produce one kilogram of drinking water. The high energy cost makes such devices luxury items in countries where cheap clean drinking water is available and un-affordable in countries where people desperately need better drinking water.

Thus a more energy efficient atmospheric water extraction method without using a refrigeration cycle, and without heating re-generation of an absorption medium, is desired. The current invention takes innovative approaches that use no refrigerant, and need no heating re-generation of absorption medium, thus save energy.

### SUMMARY OF INVENTION

The invention provides energy efficient methods and apparatuses to extract one liquid substance from a mixture containing that substance. Specifically it provides methods and apparatuses to extract liquid water from a humid gaseous, liquid or solid mixture in several steps, at minimal energy cost, and for purifying such extracted water for usage. The gaseous feed can be ambient air with regular humidity, or other gases that contain water vapor. In some possible embodiments, water is extracted from ambient air to provide clean drinking water while more pleasant feeling air, with reduced humidity and pollutants, is released back to the environment.

In one particular embodiment, drinkable water is extracted from ambient air, resulting in clean air with desirable temperature and humidity for human comfort, in several steps below:
1. Ambient air is allowed into a first chamber. Air pollutants are removed by a filter as the air enters the first chamber.
2. A desiccant is used to absorb and remove air pollutants and water vapor from the air in first chamber. The water containing desiccant is then transported to second chamber. Or alternatively, the desiccant stays in chamber 1 while its water content migrates through a porous membrane and evaporates into a second chamber maintained at low pressure.
3. Water vapor accumulated in the second chamber is compressed and pumped into a third chamber, with a higher pressure than the second chamber.
4. Water vapor dissipates heat and condenses into liquid in chamber 3, then is removed and separated from the residue air. The air is released and the water allowed into filters.
5. Water purified through filters is stored in a tank for later dispense for drink usage.

In an alternative embodiment, drinkable water is extracted from ambient air with humidity, without using desiccant, in several steps below:
1. Ambient air is allowed into a first chamber. Air pollutants are removed by a filter as the air enters a first chamber.
2. Air in first chamber is then pumped into a plural of compression chambers connected in series. At each stage that the air is pumped into the next chamber, its pressure is raised and heat from compression is dissipated to keep the temperature low and near ambient.
3. After final stage of compression and cooling, the air is allowed to escape into a condense chamber at ambient pressure. The mechanical energy of air flowing out is recycled and used to help drive at least some previous compression stages, to save energy cost.
4. As the air pressure is relieved going from the last compression chamber to the condense chamber, its temperature drops below ambient temperature. Thus water condenses out.
5. The condensed water and residue air is separated. The cool residue air is used to cool previous compression chambers to help dissipate heat. The condensed water is allowed into a series of filters for purification, before being collected in a tank for later use.

The above two possible embodiments result in large energy savings, as the latent heat from water condensation is dissipated into ambient environment without need of cooling. The first method could be more energy efficient as only water vapor, but not the air needs to be compressed, and it is only compressed to a pressure lower than the atmospheric pressure. But it may introduce trace amount of pollutant from the desiccant used. The second method results in a simpler system with no desiccant as source of pollution. Unlike prior arts, current invention uses no repeated cycle of heating and cooling, evaporation and condensation of a medium matter like a refrigerant or a hygroscopic liquid. This leads to great energy savings and less contamination.

Energy efficiency is improved by an optional preliminary stage where low quality water is cycled and sprayed onto the ambient air before the described steps of processing. Such low quality water, from polluted sources or sub-standard municipal water supply, can increase the humidity of the ambient air and remove air pollutants by rinsing them out of the air. Thus subsequent water extraction steps can work more efficiently and produce cleaner water.

The present invention leads merits of big energy savings; material savings by simple designs; and clean water made available in most part of the world where energy is available. Although the embodiment examples involve drinking water from air, the invention is applicable in any material processing to separate a liquid material, from a gaseous, liquid or solid mixture.

Advantages and novelties of current invention will be apparent to those skilled in the art upon examination of the following description, which is sufficient to enable those skilled in the art to reduce the current claims to useful practice and embodiments.

### BRIEF DESCRIPTION OF DRAWINGS

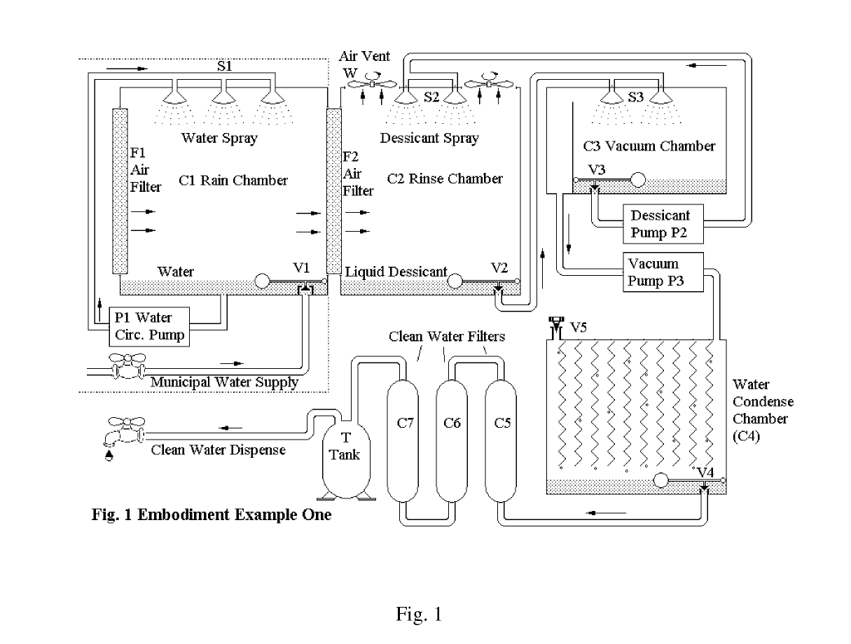

FIG. 1 is a schematic representation of an apparatus according to possible embodiment Example One based on the present invention, showing:
The dashed line of upper left part isolates out an optional part of the apparatus that uses municipal water, or any low quality water, to rinse through the ambient air, in order to increase its humidity and reduces its pollutants, before subsequent steps of processing.
Ambient outside air goes through air filter F1 to remove particulate pollutants, and enters C1, the first chamber, called rain chamber. Water from municipal supply is circulated and sprayed into the air in the chamber, increasing the humidity as well as removing most air pollutants, as the pollutants are absorbed by water and collected at the bottom. The air, purified and humidified, then passes through air filter F2 to remove remaining particles or droplets, before entering chamber C2, the rinse chamber.
The flotation valve V1 shuts off when water level is too high, and opens when water level drops, allowing more municipal water to enter. The municipal water is circulated by water pump P1 and sprayed into the C1 chamber through sprayer S1.
While the ambient air is in chamber C2, the rinse chamber, liquid desiccant is sprayed down from sprayer S2, absorbing away the water vapor contained in the air. When and only when enough liquid desiccant is collected at the bottom of C2, the floatation valve V2 opens to allow the liquid desiccant to be sucked to sprayer S3, by vacuum suction.
An air ventilation fan W ventilates the humidity removed residue air out of chamber C2 and into the environment, thus allowing fresh ambient air to enter C1 and then C2.
Chamber C3 is an enclosed chamber maintained at low vacuum by pump P2 and P3. Due to the vacuum, liquid desiccant is sucked to spray out of sprayer S3 into the chamber. Water vapor is allowed to evaporate from the desiccant into the chamber. When enough liquid desiccant collects at the bottom, floatation valve V3 opens, allowing desiccant pump P2 to circulate the desiccant back to sprayer S2 in chamber C2. Pump P3 pumps and compresses the water vapor and any residue air out of C3 into condense chamber C4.
As the water vapor is highly concentrated and contains little residue air, it condenses into liquid water under ambient pressure in chamber C4. Any accumulated excessive residue air is periodically relieved through safety valve V5. When enough of condensed water collects at the bottom of C4, floatation valve V4 opens to allow the water to be forced out.
The condensed water then goes through filters F5, C6, C7 and be purified, then enters storage tank T for later dispense through the dispense faucet.

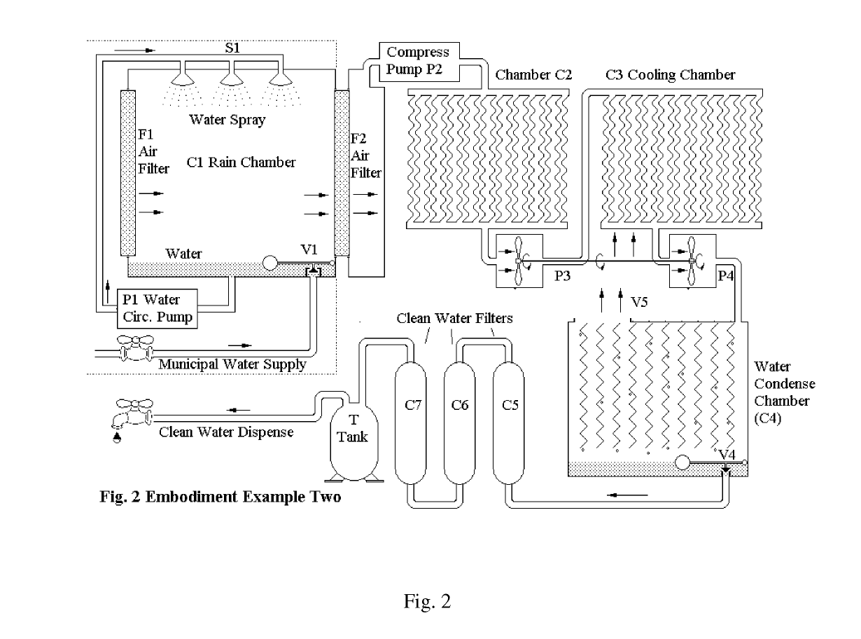

FIG. 2 is a schematic representation of an apparatus according to possible embodiment Example Two based on the present invention, with no desiccant used, showing:
The dashed line of upper left part isolates an optional part of the apparatus that uses municipal water, or any low quality water, to rinse through the ambient air, in order to increase its humidity and reduces its pollutants, before subsequent steps of processing. Its working is identical to the same in FIG. 1. So the explanation is not repeated here.
The ambient air in chamber C1, after humidification and pollutants removal by water spraying, passes through air filter F2 and is compressed by pump P2 into chamber C2, in which the air cools down and the heat from compression is dissipated.
The humid air in chamber C2, after cooling, is compressed again by pump P3, which connects mechanically with pump P4, and derives its energy from P4. The air, further compressed, enters chamber C3 to further cool down and dissipate its latent heat.
The compressed humid air is let off through pump P4 into water condense chamber C4. The energy release from pressure relief drives P4 which drives P3 to provide the energy.
The humid air in C4, with sudden pressure relief, falls below ambient temperature and thus the water vapor contained is condensed out and collected at the bottom. The residue air, still cool, is directed to help cool chamber C3 and C2 before released into the room.
The water collected at the bottom of C4 raises the floatation valve V4 and thus the water is forced into a series of filters C5, C6 and C7 for purification, before stored in tank T.

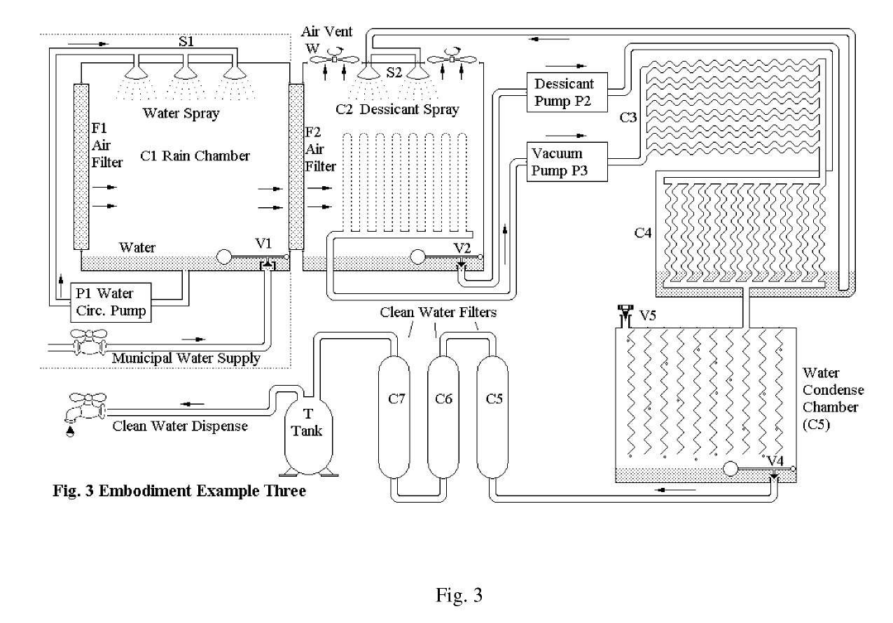

FIG. 3 is a schematic representation of an apparatus according to possible embodiment Example Three, similarly using liquid desiccant like Example One, showing:
The dashed line of upper left part isolates an optional part of the apparatus that uses municipal water, or any low quality water, to rinse through the ambient air, in order to increase its humidity and reduces its pollutants, before subsequent steps of processing. Its working is identical to the same in FIG. 1. So the explanation is not repeated here.
The humidified and purified ambient air goes through air filter F2 into chamber C2, where liquid desiccant rinses down from sprayer S2, similar to the one in FIG. 1. But there are a plural of enclosed pipes made of a porous material. Liquid desiccant saturated with absorbed water vapor would cover those porous enclosed pipes, providing opportunity for contained water vapor to migrate and evaporate into the pipes.
When excessive liquid desiccant collects at the bottom of C2, floatation valve V2 opens to allow the desiccant to be pumped out by pump P2, for circulation and heat exchange in C4 before returning to sprayer S2 and spray into chamber C2 again.
Water vapor migrates through the liquid desiccant to penetrate through the porous pipes to evaporate into the interior of these pipes. It is then pumped out by vacuum pump P3 into heat exchange chamber C3 to dissipate the heat from compression, then enters C4.
In chamber C4, the water vapor is further cooled and condenses by heat exchange with the liquid desiccant. Heated desiccant is more capable of absorbing water vapor when sprayed through S2 back into chamber C2. The desiccant is cooled when the contained water is evaporated into the porous pipes. So the cool desiccant is helpful in cooling C4.
The condensed water and residue vapor and air enters condense chamber C5 for further condensation and liquid and air separation. Excessive residue air build up is periodically vented through safety valve V5. Collected water lifts floatation valve V4 so the water is pushed out through filters C5, C6, C7, purified and stored in tank T for later dispense.

### DETAILED DESCRIPTION OF INVENTION

The present invention provides a plural of methods and apparatuses for extracting and condensing a liquid substance from a gaseous, liquid or solid mixture containing that substance, with minimal energy cost. Although the proposed three example embodiments discussed in the summary and in the description aim to extract drinking water from ambient humid air, the basic principles of the invention can be applied in a broad range of applications of substance extraction and condensation from mixtures. For one example, the methods can be applied to extract alcohol and ethanol from liquid or solid fermented waste of wine production. For another example the proposed methods can also be used to remove water content from natural gas or oil products.

The general principles of presented invention can be summed up as such: Substance extraction and condensation first by vapor separation and then by heat release from compression, and finally by condensation from de-pressurization, with the bulk of energy spent on initial compression recovered by subsequent volume expansion. The novelty lies in the fact that the latent condensation heat is naturally dissipated away, instead of removed by refrigeration.

Referring to prior arts cited and listed in the summary of invention section, these prior arts can be categorized into four types. First and second types are driven by natural forces like temperature variations, wind, and sun shine. The second type use an absorption medium material, the first type does not. The third and fourth types are both driven by artificial energy source, with the third type relying on absorption medium and the fourth type rely on operation of a refrigerant. By far the most popular type of prior arts is the fourth type that operates on a refrigerant to cool and condense water. All four types of prior arts differ fundamentally from current invention.

The current invention is novel and different from prior arts and is superior in energy savings. The current invention does not use any refrigerant, as the air itself is the refrigerant in the operation. In some embodiments, the current invention uses absorption medium like liquid desiccant. But it does not regenerate the desiccant by heating, thus the expensive energy costs related to heating, cooling, evaporation of a medium material is avoided. On the other hand, conventional methods seek to condense water out of air by direct cooling or refrigeration. Such methods result in high energy cost because of two reasons.

First, typical ambient air contains only 2% of water in volume, but all the air must be cooled to condense water. Although a heat exchanger can help pre-cool the feed air using the exhausted air, a lot of energy is wasted cooling the air and then warming it up again.

Second, as water vapor condenses into liquid, it releases a lot of latent heat. Thus it requires extra cooling power remove the latent heat, estimated at 2260 joules per gram of water.

The present invention solves these energy costing bottlenecks by first separating the water vapor from the air mixture, and then forcing water vapor to lose heat at above ambient temperature. By doing so, no energy is wasted in heating or cooling the air. Nor is energy wasted fighting against the latent heat release while the water condenses.

The apparatuses constructed based on the principles of the present invention typically contains several chambers allowing water to migrate from one chamber to the next one. Two different types of methods are proposed. One type uses liquid or solid desiccant. The other does not use such desiccant. The desiccant based method is described as embodiment Example One and Three. The method without desiccant is described as embodiment Example Two. The principles of the present invention can be understood by explanation of these three possible embodiments. The invention itself provides for many other possible embodiments beyond the three described here. All variations and improvements from example embodiments described here, without deviating from the basic principle of first forcing the latent heat to dissipate at above ambient temperature by compressing the vapor, before the vapor is de-pressurized and condensed, are intended to be included within the scope of the claims of current invention.

The novelty of current invention is in the basic principle of dissipating latent heat naturally from above ambient temperature, by vapor compression, instead of removing such latent heat from below ambient temperature by cooling or refrigeration. This basic principle is the reason for energy savings, and the reason for the novelty, non-obviousness and usefulness merits of current invention. Any variation and improvement of practical embodiments that does not deviate from this novel principle are intended to be included within the scope of the claims of current invention, whether they are explicitly referenced or not within this description.

### Prepare Clean Humid Air for Extraction

We want to obtain clean and humid air for water extraction. However the ambient air is not always in the desired condition for water extraction as provided by current invention. The ambient air may contain too much pollutants, may not be humid enough, and the temperature may be too high. Where ever possible, we want to properly condition the ambient air first. We want to remove pollutants from the air, increase its humidity, and lower its temperature.

While surface temperature and humidity vary greatly during the days and between the seasons, the underground soil layers, even just one or two meters below surface, is typically very humid and has a very stable cool temperature of roughly 55° F. year around. Such environment can provide the humidity and cooling we desire, as referenced in Claim 4, Claim 5 and Claim 13. There are two ways to utilize the underground humidity and coolness. First way is to pump air underground and let it go through the soil and rock layers, before returning to ground for further processing. Another way is to use a vacuum pump to directly suck air out of underground space. Water vapor will evaporate out of the soil and be carried out by air. Mean while, some pollutants in the air will be absorbed and trapped underground, returning only the clean, cool and humid air.

Likewise, referring to Claim 13, we desire to utilize the underground cool to dissipate heat in accordance to Claim 1 step 1C. The way to do it is to lead a pipe to the underground. As water vapor containing compressed air goes through the underground pipe, the heat is dissipated.

Now referring to FIGS. 1, 2 and 3. In all three figures, there is a square shaped dashed line in the upper left part of the figure, isolating an optional part of the apparatuses in accordance to Claim 2. This optional part uses a low quality water source to clean and humidify ambient air. This will be explained further in the explanation of embodiment Example One as following.

For subsequent discussions, we assume that the ambient air is at 80° F. with a relative humidity of 80%, and electrical motor driven compressors have 33% energy efficiency.

### Embodiment Example One

Embodiment Example One utilizes a liquid desiccant to separate water vapor from ambient humid air before next steps of processing. The apparatus for such embodiment is represented in FIG. 1. Its working principle is explained in the brief descriptions of drawings of FIG. 1, and in the section of summary of the invention found on previous pages. Further detailed explanation is provided here as following.

In some drinking water applications, there is simply no other existing water source whatsoever except for the atmosphere, thus water must be extracted from air. In some other drinking water applications, there are some existing water sources, like municipal water supply. However such water is so severely polluted that it is unsafe for drinking. Such unclean water can nevertheless be used to help improve the efficiency of an apparatus according to current invention, by clean and humidify the ambient air before next steps of processing.

Referring now to Claim 1, step 1A, the ambient air is the mixture A in the embodiment. We will prepare the ambient air by conditioning it for more efficient processing in the next steps. Also refer to Claim 2, steps 2A, 2B and 2C. The ways we condition the ambient air is by spraying the municipal water over the ambient air, making it more humid, and rinse away the pollutants. The air is further purified by passing it through air filters F1 and F2, as claimed in step 2B.

The efficiency of water extraction from air depends on relative humidity. The drier the air, the harder it is to squeeze water out of the air. On the other hand, the more humid the air is, the easier it is to get water to condense out. An ambient air with near 100% saturated humidity will see water readily precipitates out in the form of dew drops and fog droplets forming, and rains. Meanwhile it is common knowledge that after a good rain, the air is cleaner because the rain absorbs a lot of air pollutants and brought those pollutants down to the ground.

The same air cleansing principle can be applied in the example embodiment. See the upper left part of FIGS. 1, 2 and 3. A rectangular shaped dashed line isolates out an optional part of the example apparatus, depending on availability of municipal water supply. This optional chamber, called rain chamber, allows municipal water to circulate and rinse through the ambient air in the chamber C1. Water is driven through the circulation loop by water circulation pump P1.

The municipal water may be unclean to begin with, as it circulates and rinses through the air, pollutants in air are wasted down into the water, making it dirties while the air is cleaner. This is important because in many places in the world, not only clean water is in high demand, people want clean air for their homes and offices as well. The current invention provides both.

Even though it is not explicitly indicated in FIG. 1, a water filter can be placed within the water circulation loop to remove the dirty ingredients. Preferably it can be place at the bottom of C1 so the water has to go through the filter to get into the circulation pump P1. The filter can be made of inexpensive material, like paper napkins, so it can be periodically replaced and disposed of. Or it can be made of something durable and easily washable, like a plastic mesh.

Referring to Claim 2 step 2B, the ambient air must go through air filter F1 and F2 to get in and get out of chamber C1. Filter F1 is for removal of large particular particles. Filter F2 is for trapping polluted water droplets that contain pollutants. By trapping such water droplets, only clean air and water vapor can go through to next chamber C2, the rinse chamber.

Now referring to Claim 3, the original ambient air contains too much air and not much water vapor, even at near saturation humidity. We would like to get more concentrated water content. Thus we will use an absorption media, which is referred to as substance D in step 3A. The idea is substance D will first extract water from ambient air by absorption, then in step 3B, substance D pregnant with water is placed under low pressure, thus water vapor can escape out if it in step 3C. The substance D is returned to previous chamber for recycled usage in step 3D.

Now further referring to Claim 6, the substance D we use is a hygroscopic liquid, as known as liquid desiccant. It is used in chamber C2 and C3. A liquid desiccant is a liquid good at absorbing water or water vapor. Common liquid desiccants include lithium chloride, calcium chloride, lithium bromide, ethylene glycol and tri-ethylene glycol. The liquid desiccant sprays through sprayer S2 to form fine droplets, allowing maximum exposed surface area for absorption.

The water saturated desiccant then collects at the bottom of C2. Residue air, with reduced humidity and its pollutants cleansed, is expelled out into the room by ventilation fan W. Even though it is not indicated in FIG. 1, it is preferably that another air filter should be placed before the fan, so as to trap any residue desiccant droplets, lest they become air pollutants.

At the bottom of C2, there is a floatation valve V2 which controls the flow of the liquid desiccant out of the chamber. When the liquid level is low, the floating ball drops to close the valve, thus preventing any liquid or air to flow out. Only when the liquid level is high, will the floating ball be lifted to open the valve, allowing only the liquid desiccant, but not any air, to be sucked out of chamber C2 and get into chamber C3 at low pressure.

Even though it is not indicated in the drawing, a liquid desiccant filter should be placed within the pipe leading from V2 to S3, to remove impurities that contaminate the liquid desiccant. This filter should be serviced and cleaned or replaced periodically.

Chamber C3, called vacuum chamber, is an enclosed space maintained at low pressure by pumps P2 and P3. The floatation valve V3 works the same as V2. It ensures that only liquid desiccant is pumped out by P2 and circulated back to chamber C2 by sprayer S2. Water vapor will be pumped out by P3 instead, into chamber C4.

Like in C2, there is a sprayer S3 allowing liquid desiccant to spray into chamber C3 in fine droplets. This allows maximum exposed area to allow water content in liquid desiccant to evaporate into the low pressure space of chamber C3.

As shown in FIG. 1, there is a wall to the left side of chamber C3, separating the right part of the chamber which contains liquid desiccant, and the left part free of liquid desiccant. Preferably a screening filter should be placed at where the thin wall is, to trap any liquid desiccant droplets to the right side, and prevent them from contaminating the water vapor.

Pump P3 pumps the water vapor out of C3, compresses the vapor to slightly higher than ambient pressure and drives it into condense chamber C4. As the pressure rises, temperature of the vapor raises to dissipate heat. As the pressure rises above the saturation vapor pressure, the water vapor condenses into liquid water in chamber C4.

Even though FIG. 1 shows only one pump P3, in practice it can be composed of several pumps and cooling pipes connected in series. This allows the vapor temperature to stay low close to the ambient temperature. This is important in saving energy, as isothermal compression costs less energy than adiabatic compression, given the same compression ratio. More over, part of the vapor begins to condense into liquid as soon as the pressure goes above saturation vapor pressure. This reduces volume needed to be compressed, as liquid water is uncompressible, thus reduces the energy needed for compression.

Water condenses in chamber C4. The chamber contains meshes made of hydrophobic (water repelling) materials such as polypropylene or polyethylene. Hydrophobic materials are used because they provide a surface for water droplets to form, but would not allow the droplets to stick and stay. Instead the droplets easily rolls off and drop to the bottom to be collected.

Inevitably some residue air will be released from the liquid desiccant, or leaked into the chamber. When such residue air builds up in chamber C4, it is periodically let out through safety valve V5. Another floatation valve V4, working like V2 and V3, allows only water to be pushed out into filters C5, C6 and C7. Conventional water filters like sediment filters and activated carbon filters are used here. Collected water in the tank T is clean and ready for use.

Referring to Claim 14, in an improved embodiment, the clean water is allowed to pass through some clean mineral rocks and sands, before collected in tank T. This way the water acquires healthy trace amounts of helpful minerals. Such water tastes better and more natural.

Embodiment Example One is thus described. Embodiment Example Three uses the same liquid desiccant as Example One, but does not have a separate vacuum chamber, further it circulates the liquid desiccant for part of the cooling after compression. More details on it later.

### Embodiment Example Two

Unlike the previous example, Example Two does not use liquid desiccant to separate water vapor from air before compression. Instead it compresses the ambient air containing vapor. To save energy, the apparatus uses multiple stages of compression; the energy of final stages of compression is provided by recycled energy released when the air is finally de-pressurized.

Water extraction capacity of desiccant based embodiments is limited by the rate of how fast the desiccant can absorb and release water vapor, which may be a practical bottleneck. An apparatus without desiccant, as described here, has no such bottleneck, and is limited only by the throughput of compression pumps. So it has good potential for large factory scale production.

As shown in FIG. 2, the upper left part of the apparatus is an optional part that utilizes municipal water or other unclean water sources to humidify and clean the ambient air before next steps. This optional part was already explained in Example One, so it is not repeated here.

The humidified and cleaned ambient air passes through air filter F2 and is compressed by pump P2. The compression raises the temperature of the air. So the air passes through a heat exchange chamber C2 to dissipate the heat into the environment. Cooling before compressing further helps to reduce energy cost. As we know, isothermal air compression costs less energy than adiabatic one for equal compression ratio.

Now referring to Claim 10, even through FIG. 2 shows only two stages of compression and cooling, improved embodiments can utilize more than two stages of compression to improve energy efficiency, but at a cost of increased complexity and manufacturing unit cost.

P3 is a compression pump. P4 is a compression pump working in reverse. Notice that P3 and P4 are connected together mechanically and share the same rotation axis. As compressed air in the final cooling chamber C3 is released through P4 into condense chamber C4, the pressure drops to slightly higher than ambient pressure. The depressurization pushes the air through P4, releasing energy. The mechanical energy is thus recovered by P4. The energy is passed back to P3 to drive it to compress more air from C2 to C3. This saves energy.

Note P3 lifts the pressure from base pressure higher than ambient to begin with, i.e., pressure in chamber C2, and lifts it to the final pressure in chamber C3. But P4 de-pressurize from the same high pressure all the way down to ambient pressure. So given the same volume of air goes in and out of chamber C3, the air going out through P4 must release a higher amount of energy than what it takes to pump the air through P3. Therefore, the pumping operation of P3 and P4 can be self sustained, as long as pump P2 maintains an adequate pressure in C2.

The optimum operating pressure in chamber C2 and C3 can be calculated theoretically and determined by experiment, to provide optimum energy saving. I will not elaborate here.

As the fully cooled air depressurizes through P4 and enters condense chamber C4, the air cools down to a temperature below dew point, thus water condenses out. Like described in previous example, meshes made of hydrophobic materials, like polypropylene or polyethylene, are used in the chamber to facilitate water droplet collection. Even so called super hydrophobic materials like perfluoroalkyl and perfluoropolyether could be used for this purpose. The idea of using a hydrophobic material mesh to facilitate water condensation does not deviate materially from the basic principles of the current invention, and is intended to be included within the scope of the claims of current invention.

After condensation, the water collected passes through floatation valve V4 and goes through water filters C5, C6 and C7 to collect in storage tank T, as explained previously.

FIG. 2 shows that the residue air exits chamber C4 without restriction. In practical embodiments, the air flow out of chamber C4 is restricted so as to lift pressure in C4 to slightly above the ambient pressure. The extra pressure pushes the collected water through filters.

Now referring to Claim 11, the exit residue air is cooler than ambient temperature. Thus the exit air is directed to pass through chamber C3 for heat exchange, to further cool down the air contained in C3 to below ambient temperature. The more we lower the air temperature before the depressurization, the lower it drops below dew point after depressurization, and the more water will be condensed.

Referring to Claim 11, after heat exchange in chamber C3, the exit residue air should also pass through the outside of chamber C2 for more heat exchange and cooling, before taking the heat away into the open air. This will maximize the energy savings.

### Embodiment Example Three

As stated previously, embodiment Example Three is similar to Example One in using a liquid desiccant, but different in a few aspects. Please refer to FIG. 3 and compare it to FIG. 1 for the differences. Whereas it is the same between the two examples, the same explanation will not be repeated here. Whereas there are differences, the differences are explained as following.

In Example Three, a separate vacuum chamber as the C3 in FIG. 1 is eliminated for a simplified design. Instead, a plural of enclosed porous pipes are placed into chamber C2. Refer to Claim 7, these porous pipes serve as the vacuum chamber. Liquid desiccant sprays down from S2. After absorbing water vapor from air, the desiccant covers the surface of the porous pipes.

As the liquid desiccant is sticky, it forms a thin membrane which fully covers the surface of the porous pipes. This blocks the air in the chamber from entering into the pipes. However, water vapor with the desiccant can migrate through the thin liquid membrane and get close to the surface that is exposed to the vacuum in the interior of the porous pipes. So the water can easily evaporate into the pipes, and be pumped away, while the air is blocked behind.

The enclosed porous pipes can be made of fiber glass materials or porous ceramics with many sub-millimeter side holes, or other similar material. It must be thin, but yet strong and lasting enough to withstand the pressure difference. The key is the material should be wet by the selected type of liquid desiccant, so the liquid will completely cover the whole surface reliably to completely block way the air. Yet the liquid membrane formed must be thin to allow migration of water molecules from one side of the membrane to the other side. This affects the throughput capability of the system, and the ultimate water producing capacity.

Another worth noting difference of Example Three from Example One is that in Example Three, multi-stage cooling is utilized, with circulated liquid desiccant used to help cool the final cooling stage, before recycled back to sprayer S2. Why use liquid desiccant to cool? That's because as the water from desiccant evaporates into the porous pipes, the water evaporation absorbs large amount of heat which cools the desiccant. So it is perfect to use the cool desiccant to cool down the vapor more to condense more water into chamber C5. More over, the desiccant will absorb the heat and carry it into chamber C2, and allow the heat to be brought away by the residue air exiting air vent W. This is an efficient path to bright away the heat.

Although FIG. 3 shows that liquid desiccant only exchanges heat in cooling chamber C4, in an improved embodiment, it should also go through cooling chamber C3, before bringing the heat back to chamber C2 and pass the heat to exiting air. That improves energy efficiency.

A full fledged condense chamber C5 may not be necessary, as water already condenses in C4 as the vapor cools. Thus hydrophobic mesh materials should be placed in the pipes in C4 to help water condensation. So chamber C5 should just serve as a liquid and air separator by V4 and V5.

All three example embodiments of current invention have been fully explained thus far. There can be many variations and improvements. For example, referring to Claim 8, a solid desiccant can be used instead of liquid desiccant. For another example, referring to Claim 9, multiple stages of compression and cooling can be used to improve energy efficiency. For yet another example, referring to Claim 13, low and stable ambient underground temperature can be utilized for heat dissipation required in Claim 1 step 1C, by leading a pipe to the underground.

All such variation and improvements do not deviate from the basic principle of separating the vapor from the mixture substance before extraction, and compressing the vapor to force latent heat dissipation at above ambient temperature. Thus any such variations and improvements are intended to be included within the scope of the claims of current invention.

### Current Invention is Greener and More Energy Efficient

There are a number of prior arts of water extraction from atmosphere. There are a number of commercial products in the marketplace doing the same. All such prior arts are costly in energy due to the need of refrigerant assisted cooling and heat leaks.

Typical household commercial atmosphere water extraction units cost roughly 0.5 or more KWH of electricity to produce one liter or one kilogram of water at ideal humidity and temperature. If the humidity and temperature is less than ideal, the energy cost is much more.

For a reference, let me calculate the theoretically limit of highest possible energy efficiency of atmosphere water extraction, assuming all devices work at 100% efficiency and everything works at physical limits of their best efficiencies. How much energy is needed to condense water from ambient air at 80° F., roughly 27° C. or 300° K, and 80% relative humidity?

What it takes to extract water when the relative humidity is 100%? It takes nothing, because fully saturated air will begin to condense water on its own without energy input. So what it takes to lift humidity from 80% to 100%? What is the difference? The percentage concentration of water vapor in air is different. More specifically the entropy is different. Entropy is calculated as k*Ln(Ohm), with k being the Boltzmann constant, Ln being the natural logarithm function, and Ohm being the probability difference. Thus entropy change for a single water molecule, going from 80% humidity to 100% humidity, is k*Ln(100%/80%)=0.223 k.

In thermal dynamics, temperature is the ratio between energy and entropy. Energy change equals to entropy change times the temperature in ° K, so the energy needed per molecule of water equals to 0.223 k*T, with T=300° K. The result is 66.9 k. For the macroscopic scale quantities, it is easier to use the ideal gas constant R, instead of K. So the energy cost to rise water from 80% humidity to 100% humidity would be 66.9Rx° K=66.9×8.314462 Joules/mol=556 Joules/mol. One mole of water is 18 grams. So one kilogram of water contains 55.6 moles. So the ideal energy cost to extract one kilogram of water will be 556×55.6=30914 joules. It's easy to remember as both numbers are 556, or just 555 will be close enough. To translate 30914 joules to electricity KWHs, you divide it by a thousand and then by 3600 seconds in an hour. The result is 0.0086 KWH of electricity to extract one kilogram of water from 80° F. and 80% humidity air. That is assuming everything works perfectly 100% at physical limits.

The state of the arts of current commercial atmosphere water makers are about 100 times worse than the theoretical limit. Let us assume a ⅓ efficiency of electricity to mechanical energy and another 30% efficiency for compression, refrigeration etc transforming mechanical energy into thermal energy, that cut the ideal efficiency by ten times. There is still a ten times difference from the theoretical efficiency limit, to what can be reasonably achieved. There must be some room for further improvements.

By examining the three example embodiments of current invention as described before, the energy saving is evident to those skilled in the arts of related fields. Referring to Example One as illustrated in FIG. 1, after processing in chamber C3, only the water vapor that escaped from the desiccant needs to be compressed by pump P3. The quantity of vapor for compression is small. The pressure of compression is also small. So it costs very little energy.

For an example calculation, the ambient air is at 80° F. and 80% relative humidity. So the water vapor pressure is 21.4 mmHg. If the water content can migrates efficiently through the liquid desiccant and enter into chamber C3, the resulting vapor pressure in the chamber is 16 mmHg. Since water saturates at 26.74 mmHg at the given temperature, we merely need to compress the vapor isothermally from 16 mmHg to 26.74 mmHg pressure for water to begin to condense. The total compression energy needed is n*RT*Ln(26.74/16)=0.5136 nRT. To extract one mole or 18 grams of water, the compression energy cost is 1280 joules, or 71K joules per kilogram of water. In terms of electricity the cost is 0.02 KWH. Assuming that the compression pumps has an energy efficiency of 33%; the electricity cost is 0.06 KWH per kilogram of water. Such energy cost is much lower than that of similar commercial products available today.

Not only current invention provides energy savings, it also results in cleaner water. In Example Two, as illustrated in FIG. 2, neither liquid desiccant nor any refrigerant is used. Thus the biggest source of pollutant contamination is eliminated from the system. Is refrigerant still used? Yes. Actually the air itself acts like a refrigerant, as the air is first compressed to release heat and then de-pressurized to cool the water vapor into liquid, absorbing away the latent heat.

The basic physics of air compression, humidity, water evaporation and condensation is known for a long history. It is known that by compressing air, water may come out. Makers of air compressors have to struggle with removing water condensation so as to prevent corrosion damage to equipments. However, all existing commercially viable atmospheric water makers choose to utilize the approach of direct cooling and condensation by operation of a refrigerant.

The reason is that it is not obvious that air compression is a more energy efficient approach. By Compressing the air, the vapor concentration per volume increases, making it easy for water to condense. However, compression raises the air temperature to much higher above the dew point. Thus it is perceived as going against the goal to condense water, and perceived as more costly in energy consumption. However compression makes it easier to lose heat without the expensive process of refrigeration, so the novel approach ends up actually saving energy.

Thus current invention, as fully described and set forth by the claims, is novel, non-obvious and can be reduced to useful embodiments by those skilled in the arts of related fields. All modifications and improvements of practical embodiments do not deviate from the underline principles described herein, are included within the scope of the current claims listed thereafter.

1. A method of extracting liquid substance W from solid, liquid or gaseous mixture A, one particular example of which is extracting liquid water from ambient air, by evaporation, compression and condensation and using steps comprising:
1A. preparing mixture A by filtering, absorption, evaporation or purification procedures;
1B. compressing gaseous mixture A containing substance W and raise its temperature;
1C. allowing compressed mixture A to dissipate heat into the ambient environment;
1D. allowing mixture A to return to ambient pressure, and substance W to condense;
1E. separating liquid W and purifying and sanitizing it before storing it in a storage tank;
1F. dispensing liquid W collected in storage tank for usage.

2. A method in accordance to claim 1, wherein mixture A is prepared in accordance to step 1A to assist subsequent steps 1B through 1F, by using optional steps comprising:
2A. spraying low purity liquid W onto gaseous mixture A and collecting the liquid;
2B. passing gaseous mixture A through one or a number of filters for purification;
2C. circulating collected liquid W through a filter, then through apparatuses uses in claim 1 step 1C for heat exchange, before returning for recycled usage in step 2A.

3. A method in accordance to claim 1, wherein mixture A is prepared in accordance to step 1A to assist subsequent steps 1B to 1F, by enriching content W using steps comprising:
3A. allowing mixture A to make contact with liquid or solid substance D that absorbs W;
3B. transferring substance D from first space into second space with low pressure;
3C. allowing W and residue mixture A to escape from D into a low pressure space;
3D. allowing substance D to return to first space, for recycled usage in step 3A.

4. A method in accordance to claim 1, where mixture A is a gaseous mixture containing substance W extracted from a solid substance, like wet soil; Mixture A is prepared in accordance to step 1A, by placing said solid matter A in an enclosed space with reduced pressure to encourage gaseous mixture A containing W to evaporated from said solid.

5. A method in accordance to claim 1, where mixture A is a gaseous mixture containing substance W and is extracted from a solid matter that contains W, like underground soil wet with W; Mixture A is prepared in accordance to step 1A, by sllowing ambient air to go through a pipe to make contact with said solid matter, thus allowing substance W and other gases to escape from said solid matter into said ambient air, thus forming mixture A which is collected for further processing in next steps according to current claims.

6. A method in accordance to claim 3, wherein:
Said substance D in step 3A is a liquid desiccant good at absorbing substance W;
D is sprayed into first space in step 3A and sprayed into second space in step 3B;
D is transferred between the first and second space in a loop of pipes and a pump.

7. A method in accordance to claim 3, wherein:
Said substance D in step 3A is a liquid desiccant good at absorbing substance W;
D is sprayed into first space and collected onto a porous membrane or mesh fabric separating first space and second space in step 3A;
Substance W contained in D migrates towards the surface of said membrane or mesh fabric that is exposed to the second space as in step 3B;
W and some mixture A escapes into the second space in step 3C by evaporation due to reduced pressure in the second space;
D is recycled for reuse within the first space, as in step 3D.

8. A method in accordance to claim 3, wherein:
Said substance D is a solid desiccant good at absorbing liquid substance W;
D is transferred between first space and second space in steps 3B and 3D by mechanical means, like a rotating wheel constitute of substance D and that separates first space and second space and rotates in between the two spaces.

9. A method in accordance to claim 1, wherein processing steps 1B and 1C comprise of multiple stages of compressing mixture A and letting mixture A to dissipate heat, thus elevating pressure of mixture A while keeping its temperature low in multiple stages.

10. A method in accordance to claim 1, wherein:
Steps 1B and 1C comprise of multiple stages of compressing and heat dissipation;
The final pressure of mixture A is higher than ambient pressure after the last stage of compression and heat dissipation;
Mechanical energy is released in step 1D as mixture A returns to ambient pressure;
Said mechanical energy release is recycled to be used in driving at least some stages of compression in step 1B so as to save total energy cost.

11. A method in accordance to claim 1, wherein:
Final pressure of mixture A after the last stage of compressing in step 1B and heat dissipation in step 1C is higher than ambient pressure;
Temperature of residue mixture A after step 1E is lower than ambient temperature;
Said residue mixture A is used to assist the heat dissipation in step 1C.

12. A method in accordance to claim 1, wherein liquid substance W is separated in step 1E but is not processed further, and is simply disposed of, as the goal is not to extract W for usage, but simply to remove W from mixture A, like removing water from natural gas, or like dehumidifying and cleaning air in closed living space for comfort.

13. A method in accordance to claim 1, wherein in step 1C, the mixture A is forced into a pipe leading to an underground location to dissipate heat into underground environment, before said mixture A is returned for further processing in next steps.

14. A method in accordance to claim 1, wherein the liquid substance W extracted is water, and after the water is purified and sanitized in step 1E, it is allowed to make contact with mineral rocks and clean sands to introduce healthy mineral contents and improve taste, before the water is collected into a storage tank in step 1F.

15. An apparatus in accordance to the method in claim 1.

16. An apparatus in accordance to the method in claim 2.

17. An apparatus in accordance to the method in claim 3.

18. An apparatus in accordance to the method in claim 4.

19. An apparatus in accordance to the method in claim 5.

20. An apparatus in accordance to the method in claim 6.

21. An apparatus in accordance to the method in claim 7.

22. An apparatus in accordance to the method in claim 8.

23. An apparatus in accordance to the method in claim 9.

24. An Apparatus in accordance to the method in claim 10.

25. An apparatus in accordance to the method in claim 11.

26. An apparatus in accordance to the method in claim 12.

27. An apparatus in accordance to the method in claim 13.

28. An apparatus in accordance to the method in claim 14.
